(19) United States
(12) Patent Application Publication
(10) Pub. No.: US 2012/0204806 A1
(43) Pub. Date: Aug. 16, 2012

(54) TREADMILL FOR DISINFECTING PET PAW PADS

(76) Inventor: Andrea SANT'ANNA, Campinas (BR)

(21) Appl. No.: 13/369,770

(22) Filed: Feb. 9, 2012

(30) Foreign Application Priority Data
Feb. 10, 2011 (BR) PI1100308

(51) Int. Cl. A01K 13/00

(52) U.S. Cl. 119/656

(57) ABSTRACT

A TREADMILL FOR DISINFECTING PET PAW PADS, having a mechanical treadmill built from a rectangular structure that houses two transversal axles at opposite ends and mounted upon which are two rollers which feed an adhesive strip. The adhesive strip is coiled in such a way that the distance between the rollers forms an upper surface walking belt including an adhesive area that provides adherence to residual waste when coming into to contact with pet paws (cats and dogs). Said adhesive area is the exposed surface of the adhesive strip that when submitted to an applied force it reacts by spinning both rollers installed on the axles in the same direction, thus moving the adhesive strip.

### CROSS REFERENCE TO RELATED APPLICATIONS

This application claims priority of Application No. Pl1100308 filed in Brazil on 10 Feb. 2011 under 35 U.S.C.§119; the entire contents of which are hereby incorporated by reference.

### FIELD OF THE INVENTION

This patent request concerns a “TREADMILL FOR DISINFECTING PET PAW PADS”. The invention in question is notable for its individual and original characteristics, in particular it is meant to easily and efficiently disinfect, clean and sanitize domestic animals' (cats and dogs) paw pads, removing dirt and bacteria, by way of a mechanical treadmill whose walking belt contains a sliding adhesive strip.

### BACKGROUND OF THE INVENTION

In collective living areas such as apartment blocks, pet ownership (mainly that of cats and dogs) is becoming increasingly common and the obvious physiological or recreational necessities of these animals force their owners to frequently walk them in public spaces. Intrinsically related to this activity is the inevitable exposure of pets to communal areas in the buildings or condominiums in which they live. Many of these pets are small and owing to the affinity they have with their owners, share furniture, such as beds and sofas, with members of the household.

The technique currently used to clean pet paws after a walk is to apply wet towels, cloths or kitchen paper before entering the home, thus conserving the cleanliness and daily hygiene contained therein.

As with the cleaning of hands, feet and shoes (done in wash-rooms equipped with appropriate devices containing rubbing alcohol), this method should also be applied to pet paws. However, there is currently no technique available that permits this type of cleaning on pets without owners using their own hands. As such, we are presented with many situations in which the process of cleaning and sanitation is indeed corrective rather than preventive. There is currently no form of prior protection before the animal enters the home and as such, the health of household members is put at risk with current methods even promoting the distribution of contaminating agents.

### SUMMARY OF THE INVENTION

The basic function of this invention, the “TREADMILL FOR DISINFECTING PET PAW PADS,” is the sanitation and elimination of dirt and waste from pet paws before they actually enter household living areas. The treadmill is a mechanical structure, on which two parallel axles are mounted and these axles in turn sustain two cylindrical rollers that are covered by an adhesive strip. This adhesive strip forms the treadmill walking belt. Because the adhesive strip is fixed onto both rollers, the distance between them creates a surface area with adhesive properties. The treadmill is mechanical and operated by the movement of the pet on the walking belt, which then forces the axles to spin and transfers the hitherto unused adhesive strip from one roller to the other after the dirt has stuck to it.

Further scope of the applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is the perspective view of this invention;

FIG. 2 is the lateral view of this invention;

FIG. 3 is the overview of this invention;

FIG. 4 is the perspective view of this invention's refill.

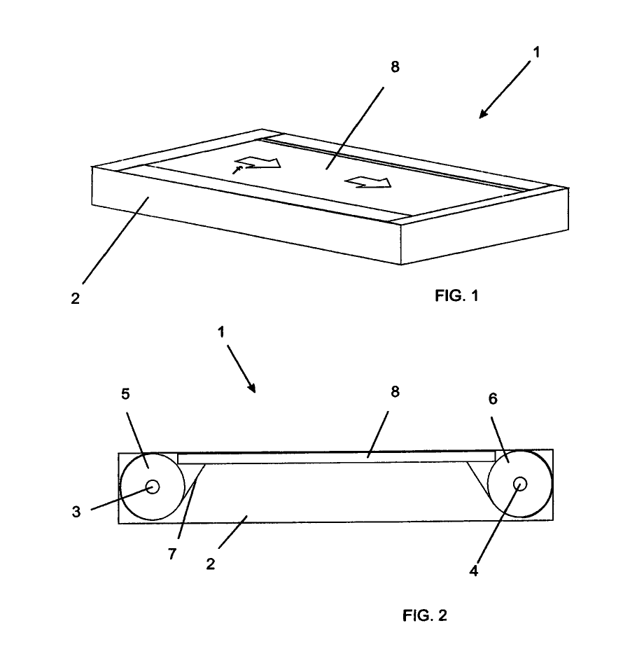

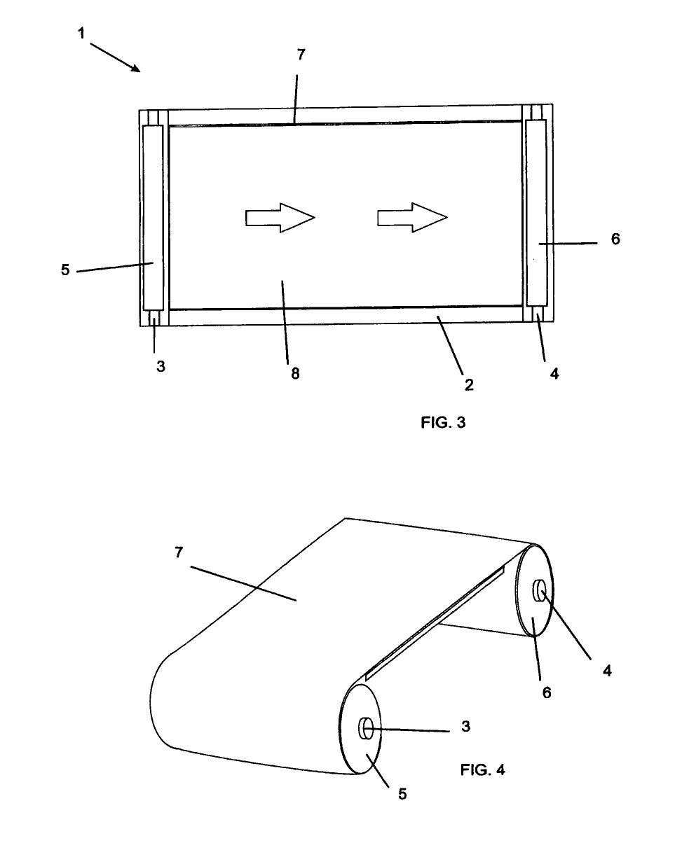

### DETAILED DESCRIPTION OF THE PREFERRED EMBODIMENTS

The following detailed descriptions should be read and interpreted whilst referring to the designs presented. The designs they are highly diagrammatic, but represent a single form of the “TREADMILL FOR DISINFECTING PET PAW PADS.”They do not necessarily refer to the only possible scope of the invention, and are limited only to the CLAIMS explicit in the forthcoming section.

The “TREADMILL FOR DISINFECTING PET PAW PADS”, subject of this appeal for an Invention Patent, consists mainly of a mechanical treadmill (1) comprised of a rectangular structure (2) that houses two transversal axles at opposite extremities (3)(4) and upon which two rollers are mounted (5)(6). These rollers feed an adhesive strip (7) that is attached in such a way that the distance between the two rollers (5)(6) forms a walking belt (8), in turn exposing an area of adhesive which provides adherence to the residue contained on, and when coming into contact with, the paws of domestic animals (cats and dogs). Said adhesive area is the whole surface area of the adhesive strip (7) that is exposed when the rollers installed on the axles spin in the same direction (3)(4).

In the starting position, the bulk of the adhesive strip (7) remains coiled onto the first roller (5), while its loose end is fixed to the second roller (6). The area of adhesive strip between the rollers (5) (6) constitutes the walking belt (8) of the treadmill (1).

Part of the scope of the invention is that the adhesive strip contains disinfecting chemical products and adhesive substances on the adhesive area. It must be said nevertheless, that this invention is indeed a mechanical device by way of a treadmill (1), the walking belt (8) itself being an adhesive strip (7) with characteristics sufficient to support the weight of the pets walking over the rigid finish of the structure (1).

With this invention, in a simplified form, the adhesive strip (7) stays static and forms the walking belt (8) in such a way as to economize materials, enabling a higher efficiency in so much as the movement of the axles (3) (4) can be done by way of a crank manually powered by the individual.

It is worth mentioning that, a constructive variant of the invention includes ‘presence sensors’—electronic devices designed to activate the mechanical structure by way of an electric motor.

1) A treadmill for disinfecting pet paw pads comprising:
a rectangular structure that houses two transversal axles at opposite extremities and upon which two rollers are mounted;
said rollers feed an adhesive strip that is coiled in such a way that the distance between the two rollers forms a walking-belt and in turn exposes an adhesive area which provides adherence to the residue contained on, and when coming into contact with, the paws of domestic animals;
said adhesive area is the entire surface area of the adhesive strip, exposed when the rollers installed on the axles spin in the same direction.

2) The treadmill for disinfecting pet paw pads in accordance with claim 1, wherein, in the starting position, the adhesive strip remains coiled on the first roller and the end of which is fixed onto the second roller; the area of the adhesive strip between the rollers constitutes the treadmill's walking belt and the treadmill itself.

3) The treadmill for disinfecting pet paw pads in accordance with claim 1, wherein the pets' movement on the treadmill walking belt moves the end of the adhesive strip, thus sliding the smooth surface over the borders of the structure of the treadmill and spinning the axles in a synchronized manner which transfers the adhesive strip from one roller to another.

4) The treadmill for disinfecting pet paw pads in accordance with claim 1, wherein the rollers contain refill units which can be replaced when needed.

5) The treadmill for disinfecting pet paw pads, in accordance with claim 1, wherein the adhesive strip contains disinfectant chemical products and an the adhesive element or substance is mixed with the adhesive area.

6) The treadmill for disinfecting pet paw pads, in accordance with claim 1, wherein the treadmill is a mechanical device in that the walking belt is an adhesive strip with characteristics sufficient to support the weight of animals walking on the rigid finish of the structure.

7) The treadmill for disinfecting pet paw pads, in accordance with claim 1, wherein the treadmill includes presence sensors, wherein the presence sensors are electronic devices which initiate the mechanical movement of the axles, being driven by an electric motor.

8) The treadmill for disinfecting pet paw pads, in accordance with claim 1 wherein the domestic animals are dogs and cats.
